(19) United States
(12) Patent Application Publication
(10) Pub. No.: US 2026/0288465 A1
(43) Pub. Date: Sep. 24, 2026

(54) IDENTIFYING DECODING TECHNIQUES

(71) Applicant: NVIDIA Corporation, Santa Clara, CA (US)

(72) Inventors: Teodor-Dumitru Ene, Tulsa, OK (US); Vikram Sharma Mailthody, Urbana, IL (US); Kyle Kranen, Menlo Park, CA (US); Carl Putterman, San Francisco, CA (US)

(21) Appl. No.: 19/083,260

(22) Filed: Mar. 18, 2025

(51) Int. Cl. G06F 9/38; G06F 9/50

(52) U.S. Cl. CPC G06F 9/3818; G06F 9/5005

(57) ABSTRACT

Apparatuses, systems, and techniques to identify one or more decoding techniques to be used based, at least in part, on one or more requests from one or more users. In at least one embodiment, a processor comprises processing circuitry to identify one or more decoding techniques to generate one or more responses to one or more requests based, at least in part, on one or more constraints, and cause one or more computing resources to perform the one or more decoding techniques to generate the one or more responses to the one or more requests.

### TECHNICAL FIELD

At least one embodiment pertains to processing resources used to identify one or more decoding techniques to generate a response to a request.

### BACKGROUND

In a computing system that uses one or more neural networks to generate responses to requests, efficient use of the resources of the computing system is an important task. There may be various decoding techniques that can be applied to generate responses to the requests, but use of these techniques in a manner that efficiently uses the resources of the computing system while satisfying various constraints can be a difficult task. The amount of memory, time, or computing resources used to generate responses to requests can be improved.

### BRIEF DESCRIPTION OF THE DRAWINGS

FIG. 1 is a block diagram of an example large language model (LLM) system and input controller, in accordance with at least one embodiment;

FIG. 2 is a block diagram of an example node and user requests, in accordance with at least one embodiment;

FIG. 3 is a block diagram of an example allocation of batch slots to multiple decoding techniques, in accordance with at least one embodiment;

FIG. 4 is a flowchart of an example process to allocate batch slots to given user requests, in accordance with at least one embodiment;

FIG. 5 is a flowchart of an example process to allocate computing resources to each of one or more decoding techniques, in accordance with at least one embodiment;

FIG. 6A is a block diagram of an example generative language model system suitable for use in implementing at least some embodiments of the present disclosure;

FIG. 6B is a block diagram of an example generative language model that includes a transformer encoder-decoder suitable for use in implementing at least some embodiments of the present disclosure;

FIG. 6C is a block diagram of an example generative language model that includes a decoder-only transformer architecture suitable for use in implementing at least some embodiments of the present disclosure;

FIG. 7 is a block diagram of an example computing device suitable for use in implementing at least some embodiments of the present disclosure; and

FIG. 8 is a block diagram of an example data center suitable for use in implementing at least some embodiments of the present disclosure.

### DETAILED DESCRIPTION

In an example, techniques described herein improve performance of language model (e.g., large language model (LLM)) systems by, based on a request from an endpoint (e.g., user, computing device, etc.), identifying one or more decoding techniques that can be used to generate a response to the request and may also satisfy one or more constraints for the request (e.g., throughput constraints, latency constraints, quality constraints, and/or other constraints), allocating computing resources to perform the one or more decoding techniques, and causing the computing resources to perform the one or more decoding techniques to generate a response to the request. This addresses challenges faced in LLM systems, as the LLM systems may have various computing resources to perform various decoding techniques to generate responses to requests, but may not have any mechanism or process by which the computing resources can be allocated to specifically generate a response to an individual request that satisfies various constraints. Techniques described herein may improve LLM systems by obtaining a request from an endpoint (e.g., user, etc.) to generate a response, identifying decoding techniques that can be used to generate the response while satisfying one or more constraints associated with the request, which can be provided by the user, and causing computing resources to be allocated to be used to perform the decoding techniques to generate the response. In this manner, the LLM systems may generate responses to requests in a manner that satisfies the constraints of the request.

Techniques described herein may involve software to manage an LLM system, such as an LLM datacenter, by dynamically allocating the compute resources of the LLM system to match the compute demand of current inference workloads. The software may dynamically create new compute distribution patterns to best match various constraints and requirements of the workloads. The software may utilize information such as the state of resources available in the system as well as the state of resources required by the workloads, in order to determine an optimal allocation of available computing resources. The compute distribution patterns may represent the allocation of compute towards the main axes of quality-of-results (e.g., QoR) for inference workloads: throughput, latency, and quality. The software may improve quality along any of these axes, such as by causing one or more decoding techniques to be performed such as speculative decoding or contrastive decoding. The software may dynamically create new distribution patterns identifying one or more decoding techniques to be used in combination and allocate compute resources to be used to perform the one or more decoding techniques for each token, such as at a timescale of milliseconds.

Techniques described herein may enable an LLM system to adjust quality and latency of user requests, such as at particular times or periods, and revert back to a default behavior during a next time or period. As aggregate workload demand on an LLM system experiences systemic increases or decreases, such as at a timescale of milliseconds, techniques described herein may be utilized to instantaneously increase and/or decrease aggregate workload demand on various resources such that the system can be used in the most optimal or efficient manner. Techniques described herein may additionally signal the system to statically allocate or deallocate further resources, such as at a timescale of minutes, such that various constraints can be met and resources of the system can be used in the most optimal and efficient manner. The LLM system may be an LLM datacenter or service that may provide LLM services to users. The LLM system may include an input controller, which may be a component of the LLM system that may cause computing resources to be allocated to perform various techniques to generate responses to requests. The input controller may obtain real-time system state data from the LLM system, as well as incoming user requests and constraint data, and may determine resource allocations when a request is received, and may perform dynamic adjustments to allocations during runtime to account for changes in the state of the system, such as an influx of requests, a batch of requests completing, and/or other changes.

The input controller may ensure each node operates at an optimal workload by assigning a dynamic number of batch slots across a dynamic set of nodes to each token decode step for each request. In an embodiment, a node refers to a collection of hardware and/or software resources of the LLM system that can be used to generate responses to requests. A batch slot may refer to a collection of hardware and/or software resources that may be used or otherwise required to process or generate a token. The input controller may allocate batch slots within each node based on the optimal workload of the particular node. The input controller may dynamically allocate batch slots to be used to perform various techniques to generate responses to requests, allow requests with different QoR to be co-located on a same node, and dynamically allocate batch slots to adjust to user QoR demand or constraints.

In the preceding and following description, numerous specific details are set forth to provide a more thorough understanding of at least one embodiment. However, it will be apparent to one skilled in the art that the inventive concepts may be practiced without one or more of these specific details.

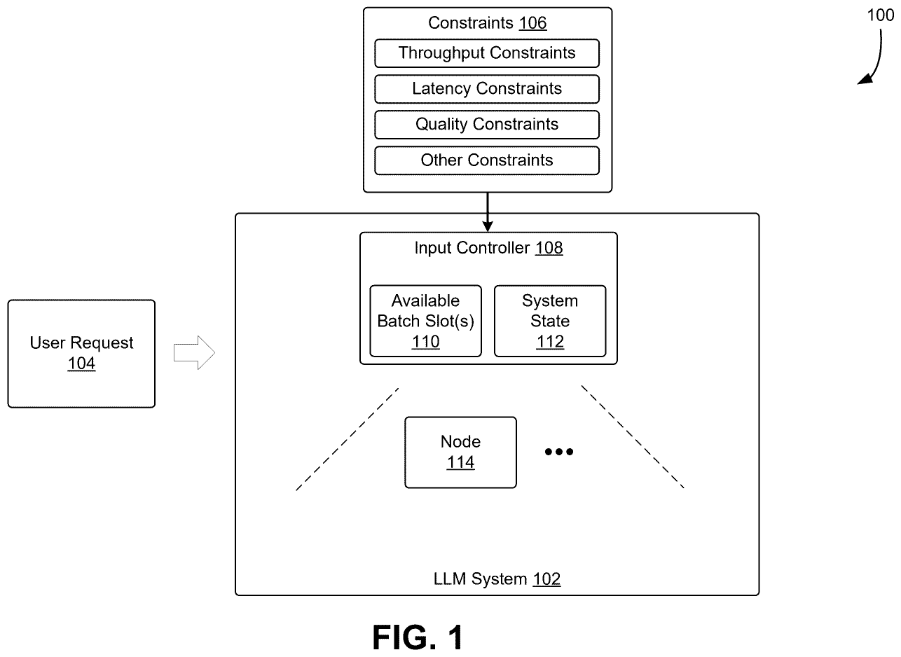

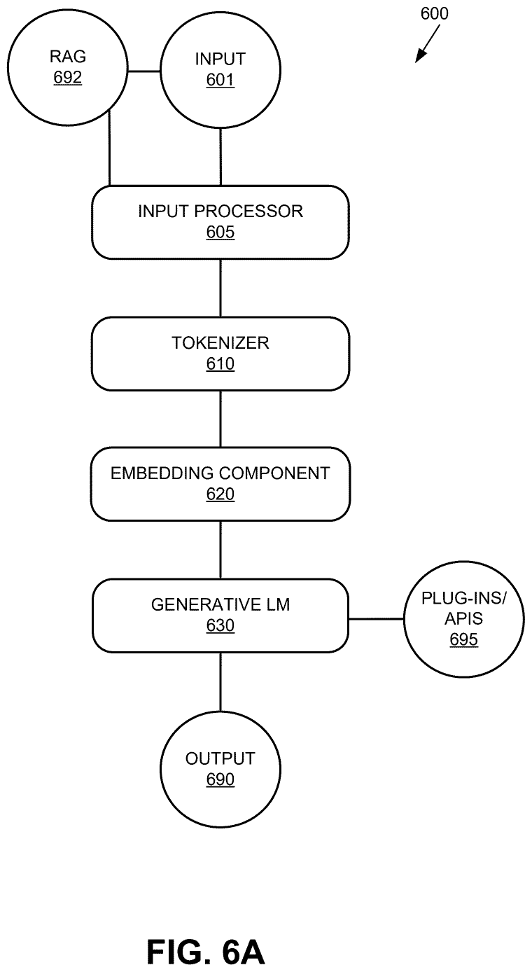

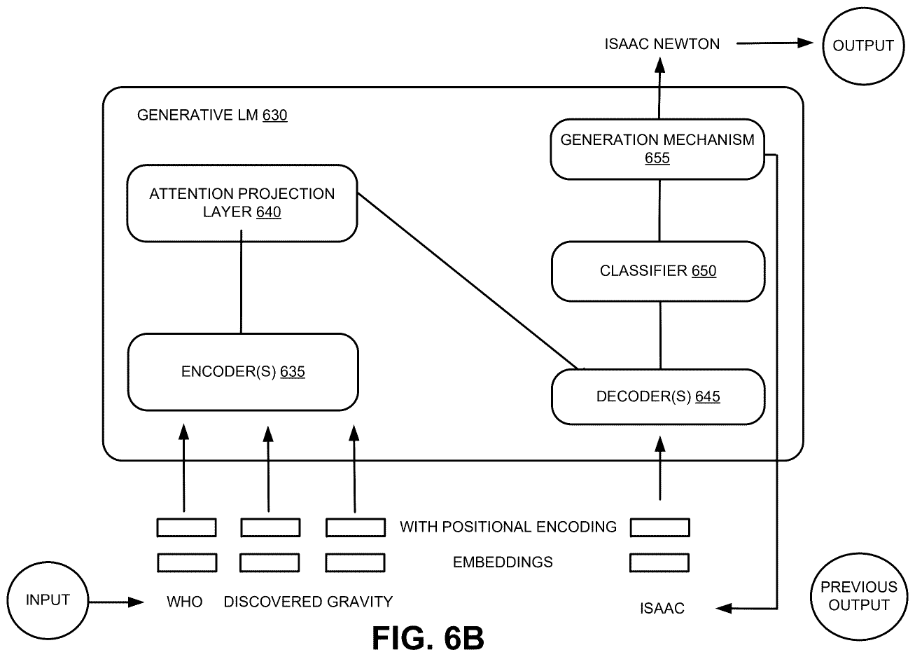

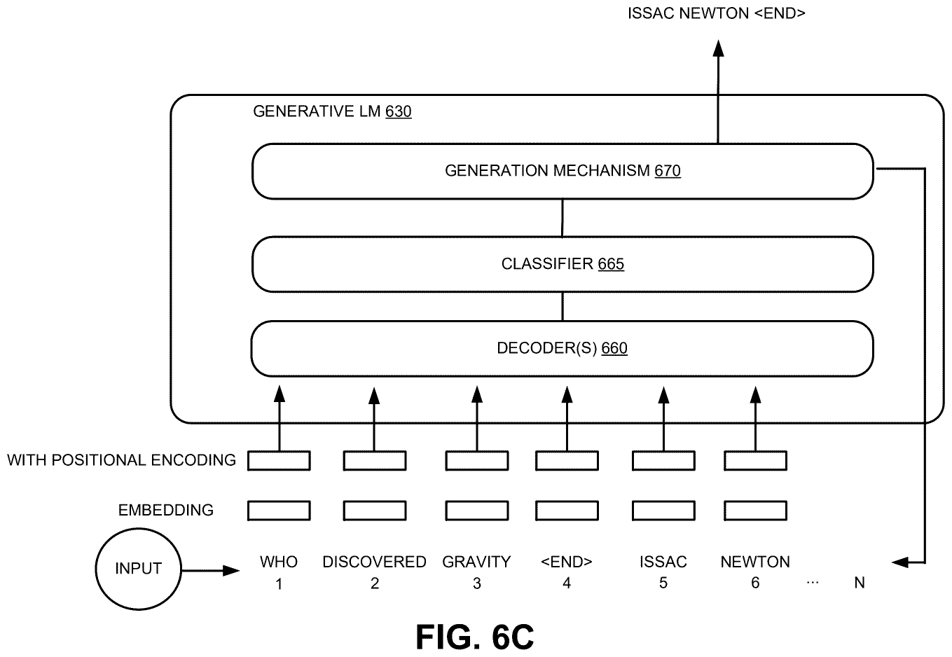

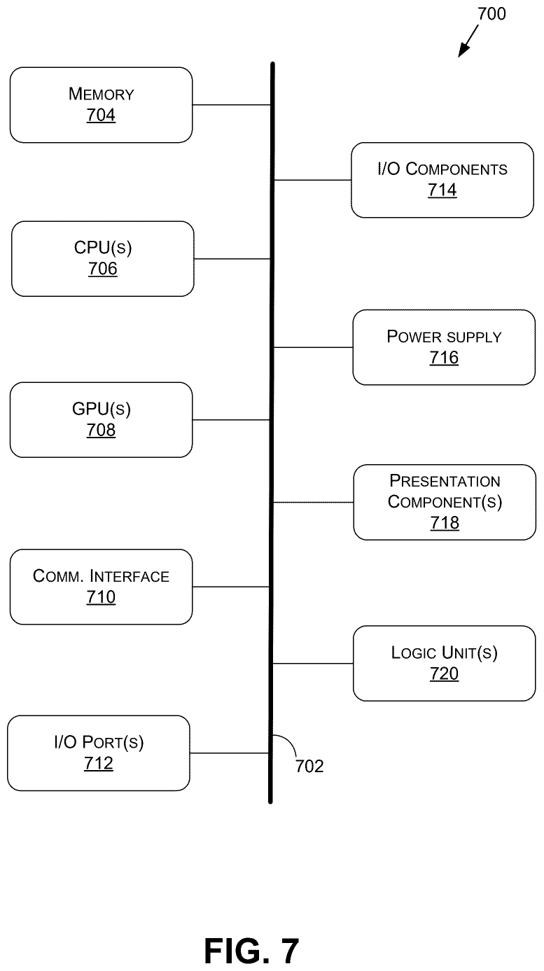

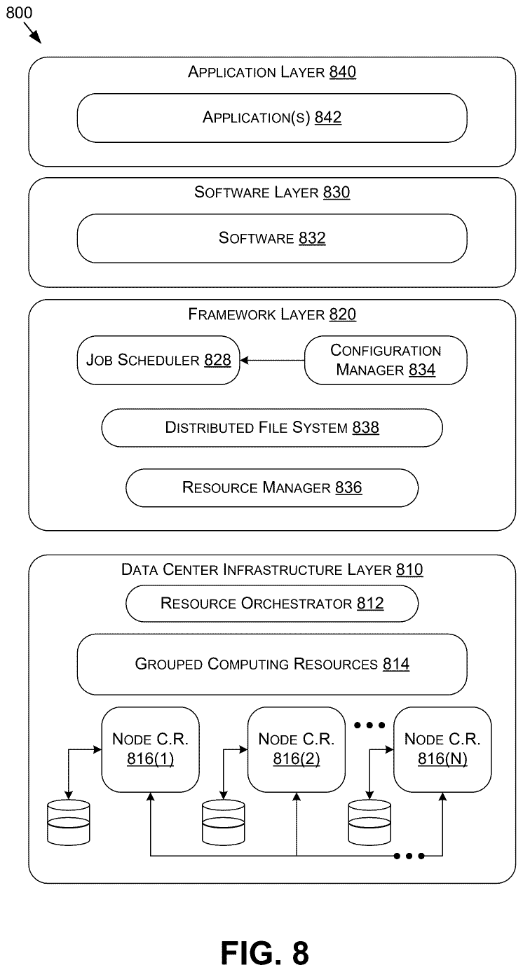

With reference to FIG. 1, FIG. 1 is a block diagram of an example large language model (LLM) system and input controller, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

System 100 may include one or more LLM system 102, user request 104, and/or constraints 106. LLM system 102 may include one or more input controller 108 and/or node 114. Input controller 108 may include one or more available batch slot(s) 110 and/or system state 112. Constraints 106 may include one or more throughput constraints, latency constraints, quality constraints, and/or other constraints. Such constraints are described in the following description.

Components of system 100 may be used to perform inferencing to generate a response to an input user request 104, wherein the inferencing has compute resources (e.g., batch slots, nodes, power, and/or any other required database resource for performance of inferencing) allocated to various techniques to perform inferencing within defined constraints for throughput, latency, quality, and/or any other constraints as defined by constraints 106. In some embodiments, constraints 106 may be included as part of user request 104, defined by LLM system 102, provided separately from user request 104, and/or any other origin. After reception of constraints and input, input controller 108 then analyzes available batch slot(s) 110 and the LLM system 102 state (system state 112), allocating batch slots (e.g., compute resources needed for processing/generation of a single LLM token) to one or more nodes, allocating said slots to performance of one or more decoding techniques during startup and dynamically during runtime to perform optimally under constraints 106.

The LLM system 102 may be a computing system or environment that may generate responses to user requests using one or more large language models (LLMs), language models, and/or any suitable models such as those described herein. In an embodiment, the LLM system 102 is an LLM inference datacenter or service. The LLM system 102 may comprise or otherwise include one or more nodes (e.g., node 114). The LLM system 102 may include or otherwise implement an input controller 108. The LLM system 102 may include hardware and/or software to implement or otherwise perform the input controller 108. The LLM system 102 may receive user inputs 104 and constraints 106, such as desired throughput, latency, and/or quality constraints, and utilize the input controller 108 to modulate batch slot allocations. LLM system 102 may use one or more decoding techniques such as those described herein to optimize the trade-offs between the three axes of inference quality (e.g., speculative decoding to improve latency, contrastive to improve quality, and idle slots to improve throughput).

User request 104 may be the inputs to LLM system 102, encompassing the tokens and data necessary for the system to process and generate responses. Constraints 106 may or may not be included within, alongside, or separate from user request 104. User request 104 may comprise the input tokens that the system uses to generate output, as well as any additional data that may influence the processing, such as context or user preferences. Input controller 108 may process these requests, taking into account the constraints provided, to determine the most suitable combination of one or more decoding techniques—such as speculative or contrastive decoding—to apply. By dynamically selecting these techniques, input controller 108 can adjust the allocation of batch slots to meet desired balance of throughput, latency, and quality, and/or the desired balance as indicated by other constraints 106.

Constraints 106 may provide the parameters that guide how user request 104 is processed and how resources are allocated. These constraints can include throughput, latency, quality, and/or other potential constraints. Throughput constraints may indicate the number of aggregate tokens per second a user can expect, influencing how many batch slots are allocated to increase processing efficiency. Latency constraints may indicate the minimum delay between consecutive tokens, in which techniques such as speculative decoding can be utilized to improve responsiveness. Quality constraints may indicate desired levels of quality, such as accuracy or correctness, of generated outputs, in which techniques such as contrastive decoding may be utilized to improve the overall quality of the output. Other constraints may indicate additional user preferences or specific requirements, such as particular decoding techniques to be applied to particular requests, resource constraints, and/or variations thereof.

In at least one embodiment, the input controller 108 is a collection of hardware and/or software computing resources with instructions that, when performed or otherwise executed, cause performance of one or more processes such as those described in connection with FIGS. 1-5. In some examples, the input controller 108 is a software program, application, or module that can be performed or otherwise executed on computer hardware. The input controller 108 may perform one or more processes such as those described herein by at least causing performance or otherwise execution of instructions by one or more processing units such as those described herein. The input controller 108 may include or otherwise maintain available batch slot(s) 110, which may be data or software that indicates an amount of available batch slots for each node 114 in LLM system 102. Available batch slot(s) 110 may indicate an amount of computing resources available to be used for inferencing in the LLM system 102. System state 112 may be data or software that indicates a state of the LLM system 102, such as resource utilization, and/or other such state information.

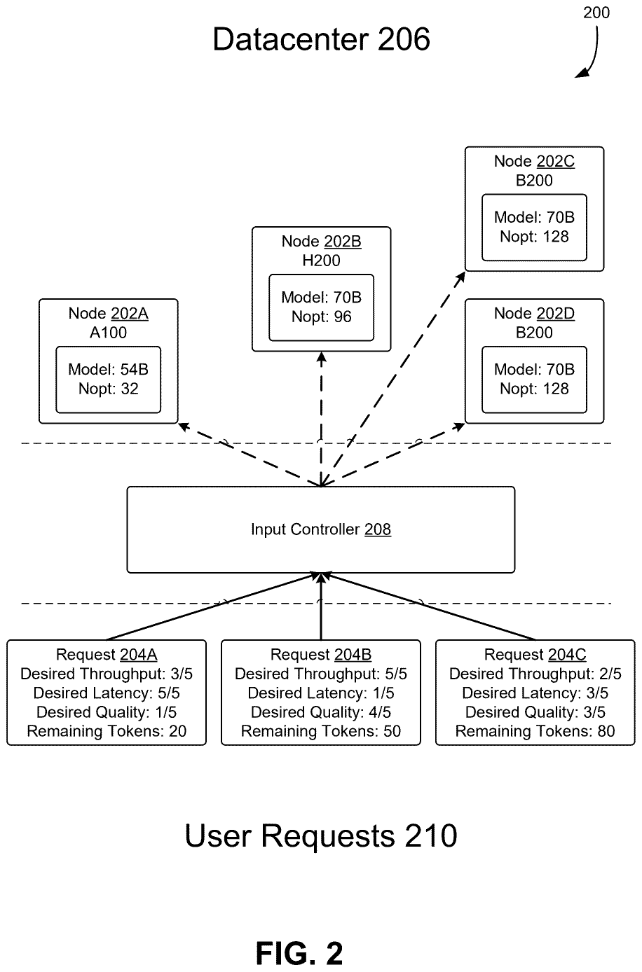

Input controller 108 may be software performed by LLM system 102, a separate processor such as a CPU, and/or any other controlling entity for LLM system 102. Input controller 108 may perform processes to manage the allocation of batch slots within each node 114 to user requests 104. Input controller 108 may operate by utilizing available batch slot(s) 110 and assessing the system state 112 to make informed decisions about resource distribution. Input controller 108 may ensure each individual hardware system operates at an empirically determined optimal number of batch slots, which can be referred to as Nopt (e.g., see FIG. 2), allowing node allocations to be optimally generated. By doing so, the input controller can adjust the allocation of resources in real-time, allowing for granular control over throughput, latency, and quality. Input controller 108 may evaluate user requests 104 and constraints 106 and determine how many batch slots are allocated to each decoding technique.

Node 114 may be defined as a group of GPUs and/or other processors (e.g., CPUs, PPUs, GPGPUs) connected by low-latency interconnects, forming a cohesive unit capable of performing inference tasks. Each node may be designed to handle specific workloads by utilizing batch slots, performing the computations needed to process or generate tokens. LLM system 102 may include one or more node 114, each with differing Nopt (FIG. 2), model types, spatial location within a datacenter (e.g., one node may be located 10 meters to the north of a server room switch of the datacenter, while another may be located 5 meters to the west of the server room switch, and/or in any suitable locations or configuration), and/or geographic locations (e.g., part of a datacenter may be located in Japan, while other parts may be distributed across the United States).

The LLM system 102 may obtain a user request (e.g., user request 104) from an endpoint (e.g., user, computing device, etc.), such as through one or more user interfaces. The user request may include text, image, and/or audio data. The user request may be a request to generate particular text, process particular text, obtain particular information, process particular information, and/or may be any suitable language model request. The LLM system 102 may also obtain constraints (e.g., constraints 106). The constraints may be provided with the user request or otherwise provided to the LLM system 102 in any suitable manner. The constraints may indicate any suitable rules or heuristics, such as rules for individual requests (e.g., a particular request should have particular throughput, latency, and/or quality levels, and the like), rules for different scenarios or states of the LLM system (e.g., if average throughput is at a particular level, latency and/or quality of a particular request should be at particular levels, and the like), and/or variations thereof. A constraint may indicate any suitable requirements or limitations on how inferencing should be performed and how results of the inferencing should be generated, such as in relation to the state of the available resources, source of requests, and/or any suitable information.

The LLM system 102 may identify one or more decoding techniques to be used to generate a response to the user request based on the constraints. The LLM system 102 may identify the one or more decoding techniques by selecting decoding techniques from a plurality of decoding techniques that may be utilized that satisfy the constraints. The decoding techniques may include any suitable decoding techniques that can be used by a language model to generate a response to a request, such as contrastive decoding, speculative decoding, best-of-n decoding, and/or any suitable decoding technique or process. In some embodiments, each decoding technique may provide a particular benefit, use, or technical advantage, in which the LLM system 102 may encode information of the benefits, uses, or technical advantages of the decoding techniques. The LLM system 102 may use such information to identify which decoding techniques are best suited to be used to generate the response to the request in a manner that satisfies or otherwise approximately satisfies the constraints.

The LLM system 102 may identify the one or more decoding techniques as those suitable to generate the response to the request in a manner that satisfies or approximately satisfies the constraints. In some embodiments, the LLM system 102 encodes a mapping of constraints to decoding techniques to be used (e.g., the mapping indicates, for particular constraints and/or combinations of constraints, which decoding techniques are to be used to generate responses to requests). As an illustrative example, the constraints may indicate a particular throughput level, latency level, and/or quality level for a particular request, in which the LLM system 102 may identify one or more decoding techniques that, when used to generate a response to the request, result in the response satisfying or approximately satisfying the particular throughput level, latency level, and/or quality level. The LLM system 102 may identify computing resources (e.g., batch slots) required to or otherwise usable to perform the one or more decoding techniques. The LLM system 102 may then allocate or otherwise cause the computing resources to be used to perform the identified decoding techniques to generate the response. The computing resources may be located or otherwise part of one or more nodes, in which the LLM system 102 may allocate computing resources of a particular node to perform one or more particular decoding techniques based on the optimal workload of that node (e.g., allocate such that the optimal amount of computing resources of the node are being utilized).

With reference to FIG. 2, FIG. 2 is an example block diagram of an example node and user requests, in accordance with at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

Components of example 200 may be used to perform inferencing of input user requests 210, comprising individual request 204A-204C, allocated each to one or more node 202A-202D of datacenter 206 by an input controller 208. In some embodiments, request 204A-204C include a desired throughput indication, desired latency indication, desired quality indication, and an indication of remaining tokens to completion. Input controller 208 may then analyze these requests and desired parameters, along with the current operational state of all nodes 202 within datacenter 206, Nopt for each node, and the connection times between nodes, to allocate batch slots of those nodes to each of the input user requests 210.

In some embodiments, node 202A-202D may be referred to as nodes 202, wherein the models, Nopt, locations, and/or any other characteristics may change between embodiments. In some embodiments, nodes 202 of datacenter 206 are an example set of nodes for an input controller 208 to provide for computation of requests 204. Nodes 202 may be a group of one or more processors (e.g., GPUs, CPUs, PPUs, GPGPUs, and/or any suitable processor) connected by low-latency interconnects, forming a cohesive unit capable of performing inference tasks within datacenter 206. Each node may be designed to handle specific workloads by utilizing batch slots (e.g., segments of computing resources or power associated with the node). These batch slots may be utilized to perform the computations needed to process or generate tokens, allowing the system to manage user requests based on batch slot allocation. In some embodiments, nodes 202 may operate under the guidance of an input controller 208 that prioritizes maintaining an empirically determined optimal number of batch slots, referred to as Nopt, allowing nodes to be neither underutilized nor overutilized, balancing the time spent reading data into compute-accessible memory and performing computations.

Request 204A-204C (e.g., requests 204) may be one of a set of input user requests 210 that are processed by the nodes 202 within the datacenter 206. These requests may be characterized by user-specified constraints, such as desired throughput, latency, quality, and remaining tokens to completion, which may guide the allocation of node resources. The input controller 208 within datacenter 206 may evaluate these constraints to determine the most suitable decoding techniques, such as speculative or contrastive decoding, to apply to each request. Each request may then be allocated to one or more nodes 202, wherein the requests and decoding techniques may be balanced against Nopt, an empirically determined optimal number of batch slots that each node should utilize to achieve maximum efficiency, before allocation is performed. In some embodiments, input controller 208 may dynamically adjust resource allocation to each of requests 204 based on real-time usage patterns, allowing requests with different Quality of Response (QoR) to be co-located on the same node, optimizing the overall efficiency of the system.

Input controller 208 may be a dynamic controller that adjusts the trade-offs between throughput, latency, and quality in a running database system based on real-time usage patterns of the database. Input controller 208, by modulating batch slot allocations, may keep each individual hardware system operating at an empirically determined optimal number of batch slots by dynamically assigning a number of batch slots to each request. By doing so, input controller 208 maintains granular control over resource allocation, allowing datacenter adjustments and facilitating the co-location of requests with different Quality of Response (QoR) on the same node.

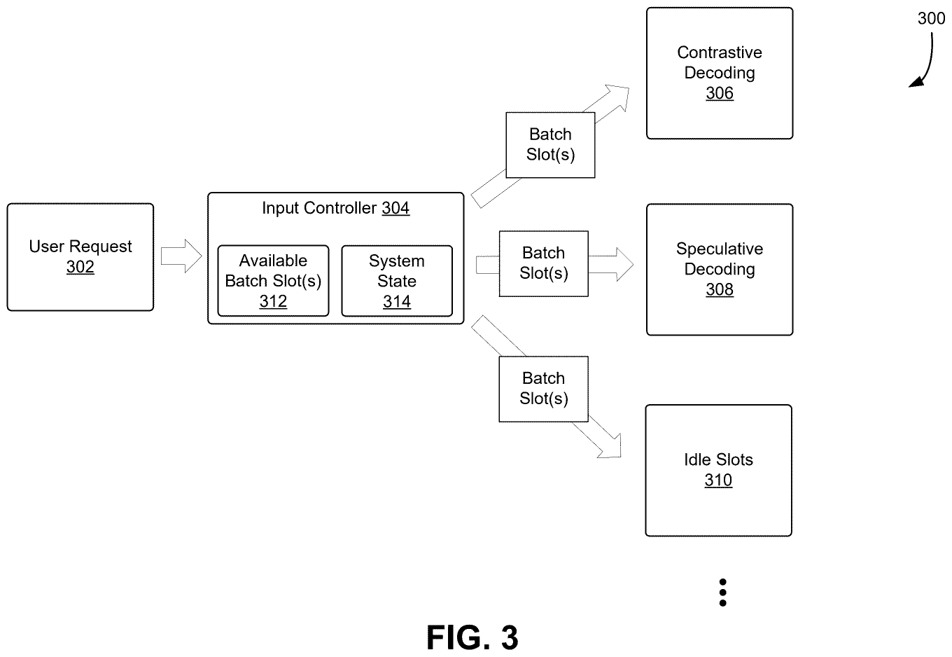

With reference to FIG. 3, FIG. 3 is an example block diagram of an example allocation of batch slots to multiple decoding techniques, in accordance with at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

Components of system 300 may be used to allocate available batch slots of an associated system of nodes to each request of a set of user requests 302. In some embodiments, system 300 includes one or more user request 302, input controller 304, contrastive decoding 306, speculative decoding 308, and/or idle slots 310. In some embodiments, input controller 304 includes one or more available batch slot(s) 312 and/or system state 314. In some embodiments, user request 302 is described in connection with user request 104 of FIG. 1. In some embodiments, input controller 304 is described in connection with input controller 108 of FIG. 1.

Contrastive decoding 306 may be a decoding technique used in large language models (LLMs) to enhance the quality of generated text by generating and comparing multiple candidate sequences. Contrastive decoding 306 may involve creating several potential continuations of a text sequence and contrasting them in order to create a novel, more suitable, continuation based on predefined quality metrics, such as coherence, relevance, fluency, and/or other quality metrics. The primary goal of contrastive decoding 306 may be to improve the correctness and utility of the generated tokens, ensuring that the output aligns closely with the user's intended use. Contrastive decoding 306 can be done in parallel with speculative decoding 308, idle slots 310, and/or other decoding techniques.

Speculative decoding 308 may be a decoding technique used in LLMs to improve latency by generating multiple possible next tokens of a text sequence simultaneously. Speculative decoding 308 may allow for rapid evaluation and selection of the most optimal continuation, thereby reducing the time delay between generating consecutive tokens. Speculative decoding 308 may be particularly beneficial in scenarios where rapid response times are critical, such as in interactive applications or real-time communication systems. Speculative decoding 308 can be done in parallel with contrastive decoding 306, idle slots 310, and/or any other decoding techniques.

Idle slots 310 may be one or more batch slots left idle, which may refer to where batch slots are not allocated to performing speculative decoding 308, contrastive decoding 306, nor any other similar decoding technique. In some embodiments, batch slots may be left as idle slots 310 to increase aggregate throughput of the LLM system. Idle slots 310 may increase throughput by allowing nodes to operate at Nopt, or an optimal number of batch slots for each node, such as when accounting for the aggregate allocation of batch slots across the entire set of user requests. By leaving idle slots 310 as an option, input controller 304 can reduce the load on a given node, operating closer to Nopt to improve operational efficiency, thereby generating more tokens per time slot. Idle slots 310 may be allocated in parallel with contrastive decoding 306, speculative decoding 308, and/or any other similar decoding techniques.

It should be noted that an input controller such as described herein may identify decoding techniques from any suitable types of decoding techniques that can be used to generate responses to user requests. These decoding techniques may include any suitable technique or process that can be used to generate a token or otherwise generate one or more language model responses or outputs. As an illustrative example, best-of-n decoding is a technique in which multiple outputs or responses are generated and a highest scoring one is selected according to one or more given metrics or criteria. The input controller may select any suitable decoding techniques or processes to be used to generate a response to a user request and allocate appropriate batch slots based on available batch slots and other state information such that the decoding techniques can be performed using the batch slots to generate the response that satisfies or approximately satisfies various constraints.

Available batch slot(s) 312 are indications of segments of compute resources (e.g., batch slots) that can be allocated to process or generate tokens. Available batch slot(s) 312 are, in some embodiments, provided to input controller 304 alongside user request 302 to indicate which batch slots across which nodes are available to be allocated to said request. System state 314 may also be provided, indicating to input controller 304 other required metrics, such as the spatial locality of available nodes relative to one another inside the datacenter, the current location within each node of cached computation results generated by previous decode steps or otherwise associated with currently active requests, and Nopts for available nodes that may influence allocation of batch slots to user request 302 and its decoding techniques (e.g., contrastive decoding 306, speculative decoding 308, idle slots 310, and/or any other decoding technique that requires batch slot allocation). The input controller 304 may obtain the user request 302, and based on the available batch slot(s) 312 and system state 314, allocate batch slots to be used to perform contrastive decoding, speculative decoding, or any suitable technique or process to generate a response to the user request 302.

The input controller 304 may obtain a user request (e.g., user request 302) from a user, such as through one or more user interfaces. The input controller 304 may also obtain constraints such as those described herein. The input controller 304 may identify one or more decoding techniques to be used to generate a response to the user request based on the constraints. The input controller 304 may identify the one or more decoding techniques by selecting decoding techniques from a plurality of decoding techniques that may be utilized that satisfy the constraints. The input controller 304 may encode information or utilize one or more models or functions that may indicate, for particular constraints, decoding techniques that can be utilized to generate a response to a request that satisfies those constraints. The input controller 304 may identify batch slots that are to be used to perform the identified one or more decoding techniques. In some embodiments, the input controller 304 identifies the batch slots from batch slots that are available to be used. The input controller 304 may then allocate the batch slots to be used to perform the identified one or more decoding techniques to generate a response to the user request. The input controller 304 may cause the batch slots to be used to perform the identified one or more decoding techniques. In some examples, the input controller 304 may allocate batch slots of one or more nodes such that each node is operating near or at an optimal workload, which can be determined in any suitable manner.

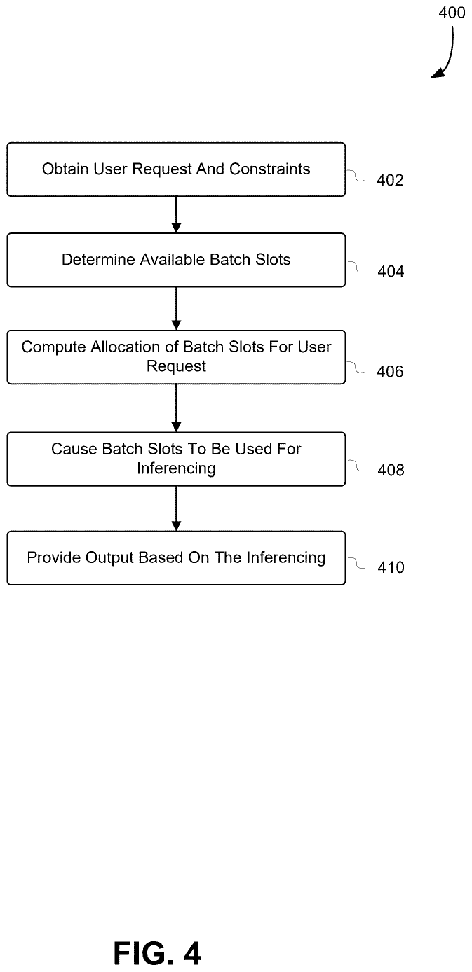

Now referring to FIG. 4, each block of process 400, described herein, comprises a computing process that may be performed using any combination of hardware, firmware, and/or software. For instance, various functions may be carried out using one or more processors executing instructions stored in one or more memories. The process may also be embodied as computer-usable instructions stored on computer storage media. The process may be provided by a standalone application, a service or hosted service (standalone or in combination with another hosted service), as a microservice via an application programming interface (API) or a plug-in to another product, to name a few. In addition, process 400 is described, by way of example, with respect to the system of FIG. 1. However, this process may additionally or alternatively be executed by any one system, or any combination of systems, including, but not limited to, those described herein.

FIG. 4 is a flow diagram showing a process 400 for allocation of batch slots to given user requests, in accordance with some embodiments of the present disclosure. The process 400, at block 402, includes obtaining user requests and LLM constraints. Such a process step may involve obtaining user requests, comprising input data for the LLM and any other required information to provide adequate constraints on inferencing, which may include said constraints, and any other constraints to the system, such as a maximum node count for each request, maximum batch slot allocations to a particular decoding technique, and/or any other required parameter and/or constraint to allow the requested LLM to perform inferencing.

The process 400, at block 404, includes determining available batch slots. Such a process step may involve receiving runtime information from all operational nodes to determine which are available, and how many available batch slots can be assigned for each.

The process 400, at block 406, includes computing batch slot allocations for the user request. Such a process step may involve comparing desired parameters, such as throughput, latency, quality, and/or other such parameters, against available nodes and/or batch slots, optimal nodes and/or batch slots, other constraints provided to the controller, and/or any other limitation, to compute an optimal allocation for the request. An input controller may compute how many batch slots are to be allocated for a user request and which decoding techniques are to be performed using the batch slots to generate a response to the user request.

The process 400, at block 408, includes inferencing using allocated batch slots. Such a process step may involve providing the computed allocations to the LLM system, as well as input data, to allow the LLM system to then begin inferencing as directed. In some embodiments, blocks 406 and 408 may be performed dynamically during inferencing, altering allocated batch slots to various techniques, such as speculative or contrastive decoding, during inferencing.

The process, at block 410, includes providing inferencing outputs to an indicated output location, such as shared memory. Such a process step may involve providing inferencing outputs to an indicated output location, then indicating to a controller that designated batch slots and/or nodes are idle, and able to accept further inputs. In some embodiments, progression of process 400 to block 410 also includes one or more indications to end the process 400.

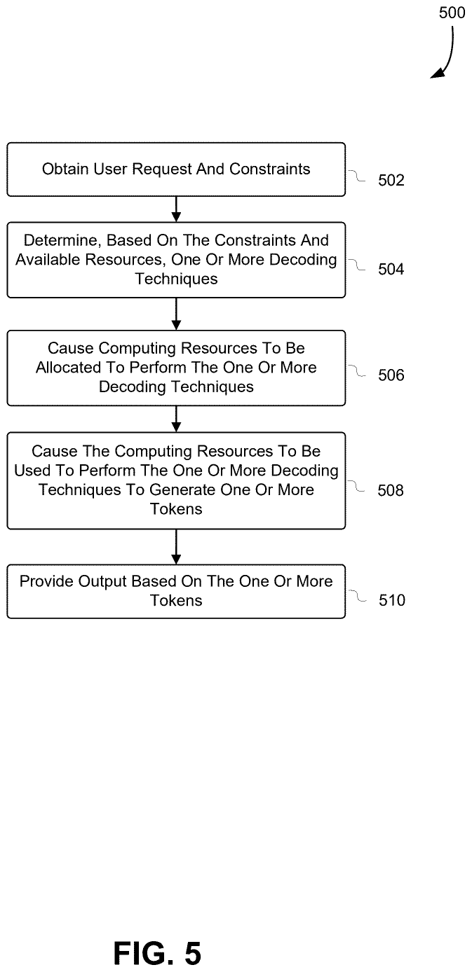

Now referring to FIG. 5, each block of process 500, described herein, comprises a computing process that may be performed using any combination of hardware, firmware, and/or software. For instance, various functions may be carried out using one or more processors executing instructions stored in one or more memories. The process may also be embodied as computer-usable instructions stored on computer storage media. The process may be provided by a standalone application, a service or hosted service (standalone or in combination with another hosted service), as a microservice via an application programming interface (API) or a plug-in to another product, to name a few. In addition, process 500 is described, by way of example, with respect to the system of FIG. 1. However, this process may additionally or alternatively be executed by any one system, or any combination of systems, including, but not limited to, those described herein.

FIG. 5 is a flow diagram showing a process 500 for allocation of batch slots to each of one or more decoding techniques for a given user request, in accordance with some embodiments of the present disclosure. The process 500, at block 502, includes obtaining user requests and constraints. Such a process step may involve obtaining user requests, comprising input data for the LLM and any other required information to provide adequate constraints on inferencing, which may include said constraints, and any other constraints to the system, such as a maximum node count for each request, maximum batch slot allocations to a particular decoding technique, and/or any other required parameter and/or constraint to allow the requested LLM to perform inferencing.

The process 500, at block 504, includes determining decoding techniques based on constraints and available resources (e.g., nodes and/or batch slots). Such a process step may involve determining a correlation between desired parameters, such as an indication of desired quality, to a number of batch slots, from available batch slots, to be allocated to one or more decoding techniques to achieve the desired parameters. For example, a request may come with a desired latency of no more than 20 milliseconds between generated tokens. In such an example, a controller may determine that 10 batch slots must be allocated to speculative decoding techniques to achieve an average latency at that rate. Said controller would then also determine batch slots required for desired quality, throughput, and/or any other desired parameters. The batch slots may then be used to perform the determined techniques to generate a response to the request within the desired latency, or as close to the desired latency as allowed by available system resources and conditions. In some examples, the decoding techniques may be identified or otherwise determined dynamically as a result of obtaining a user request.

The process, at block 506, includes causing computing resources to be allocated to perform the one or more decoding techniques. Such a process step may involve indicating, for each technique, a number of batch slots to be used perform that technique in association with batch slots performing other techniques. An input controller may cause the computing resources to be used to perform the one or more decoding techniques by providing instructions, indications, or any suitable data to nodes, computing systems associated with the resources, the computing resources, and/or variations thereof, which may cause the computing resources to be used to perform the one or more decoding techniques or otherwise indicate or cause the computing resources to perform the one or more decoding techniques.

The process, at block 508, includes causing the computing resources to be used to perform the one or more decoding techniques to generate one or more tokens. Such a process step may involve causing the individual batch slots to be utilized to perform the determined techniques. In some embodiments, allocation of batch slots to a given technique may be dynamically altered during inferencing to change with desired parameters and/or constraints. The computing resources may be used to perform the one or more decoding techniques to generate one or more tokens as part of a response to the user request.

The process, at block 510, includes providing output based on the one or more tokens. The output may comprise the one or more tokens or other suitable information or data generated based on the one or more tokens. The output may be provided to the user through a user interface, or may be stored in one or more locations. Such a process step may involve providing inferencing outputs to an indicated output location, then indicating to a controller that designated batch slots and/or nodes are idle, and able to accept further inputs. In some embodiments, progression of process 500 to block 510 also includes one or more indications to end the process 500.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms-may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation. In some examples, an input controller such as described in connection with FIG. 1 performs one or more processes such as those described herein to cause computing resources to be allocated to perform various decoding techniques of a language model to generate a response to a user request.

FIG. 6A is a block diagram of an example generative language model system 600 suitable for use in implementing at least some embodiments of the present disclosure. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a SLM, a VLM, a multi-modal LM, etc.). The generative language model system 600 may be part of or otherwise implemented in connection with the LLM system 102 of FIG. 1.

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 630 (e.g., LLM/SLMs/VLM/MMLM/etc.). In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multi-modal inputs, the input 601 may combine text (or may omit text) with image data, audio data, video data, design data, USD data, and/or other types of input data, such as but not limited to those described herein. Taking raw input text as an example, the input processor 605 may prepare raw input text in various ways. For example, the input processor 605 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 605 may remove stopwords to reduce noise and focus the generative LM 630 on more meaningful content. The input processor 605 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 692 (which may include one or more RAG models, and/or may be performed using the generative LM 630 itself) may be used to retrieve additional information to be used as part of the input 601 or prompt. RAG may be used to enhance the input to the LLM/SLM/VLM/MMLM/etc. with external knowledge, so that answers to specific questions or queries or requests are more relevant—such as in a case where specific knowledge is required. The RAG component 692 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history—or at least a summary thereof—and include the prior conversation history along with the current ask/request as part of the input 601 to the generative LM 630.

The RAG component 692 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 692 and the embeddings of the chunks along with the embeddings of the query may be compared to identify the most similar/related embeddings to the query, which may be supplied to the generative LM 630 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 692 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 610 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training dataset. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data/video data/etc., the input processor 601 may resize the data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 601 may resample an audio file to a consistent sampling rate for uniform processing, and the embedding component 620 may use any known technique to extract and encode audio features—such as in the form of a spectrogram (e.g., a mel-spectrogram). In some implementations in which the input 601 includes video data, the input processor 601 may extract frames or apply resizing to extracted frames, and the embedding component 620 may extract features such as optical flow embeddings or video embeddings and/or may encode temporal information or sequences of frames. In some implementations in which the input 601 includes multi-modal data, the embedding component 620 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use—or capable of accessing or using—plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated—e.g., recursively—for any number of iterations and using any number of plug-ins/APIs 695 until an output 690 that addresses each ask/question/request/process/operation/etc. from the input 601 can be generated. As such, the model(s) may not only rely on its own knowledge from training on a large dataset(s) and/or from data retrieved using the RAG component 692, but also on the expertise or optimized nature of one or more external resources—such as the plug-ins/APIs 695.

FIG. 6B is a block diagram of an example implementation in which the generative LM 630 includes a transformer encoder-decoder. The generative LM 630 may be part of or otherwise implemented in connection with the LLM system 102 of FIG. 1. For example, assume input text such as “Who discovered gravity” is tokenized (e.g., by the tokenizer 610 of FIG. 6A) into tokens such as words, and each token is encoded (e.g., by the embedding component 620 of FIG. 96A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 640 may convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 may generate a first token, and the generation mechanism 655 may apply the generated token as an input during a second pass. The process may repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 may output some decoded (e.g., vector) representation of the input being applied during a particular pass. The classifier 650 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 may select or sample a word or token based on a corresponding predicted probability (e.g., select the word with the highest predicted probability) and append it to the output from a previous pass, generating each word or token sequentially. The generation mechanism 655 may repeat the process, triggering successive decoder inputs and corresponding predictions until selecting or sampling a symbol or token that represents the end of the response, at which point, the generation mechanism 655 may output the generated response.

FIG. 6C is a block diagram of an example implementation in which the generative LM 630 includes a decoder-only transformer architecture. For example, the decoder(s) 660 of FIG. 6C may operate similarly as the decoder(s) 645 of FIG. 6B except each of the decoder(s) 660 of FIG. 6C omits the encoder-decoder self-attention layer (since there is no encoder in this implementation). As such, the decoder(s) 660 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 660. As with the decoder(s) 645 of FIG. 6B, each token (e.g., word) may flow through a separate path in the decoder(s) 660, and the decoder(s) 660, a classifier 665, and a generation mechanism 670 may use auto-regression to sequentially generate one token at a time until predicting a symbol or token that represents the end of the response. The classifier 665 and the generation mechanism 670 may operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 7 is a block diagram of an example computing device(s) 700 suitable for use in implementing some embodiments of the present disclosure. The computing device(s) 700 may be part of or otherwise implemented in connection with the LLM system 102 of FIG. 1. In some examples, the LLM system 102 of FIG. 1 is implemented using the computing device(s) 700. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840. The data center 800 may be part of or otherwise implemented in connection with the LLM system 102 of FIG. 1. In some examples, the LLM system 102 of FIG. 1 is implemented in connection with or otherwise part of the data center 800. The data center 800 may implement or otherwise include an input controller such as described herein.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments-in which case a server may not be included in a network environment- and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
identify one or more decoding techniques to generate one or more tokens as part of one or more responses to one or more requests based, at least in part, on one or more constraints; and
cause one or more computing resources to perform the one or more decoding techniques to generate at least the one or more tokens as part of the one or more responses to the one or more requests.

2. The one or more processors of claim 1, wherein the processing circuitry is to determine the one or more computing resources based, at least in part, on a state of a datacenter comprising the one or more computing resources.

3. The one or more processors of claim 1, wherein the processing circuitry is to use the one or more computing resources to perform the one or more decoding techniques to generate the one or more responses.
The one or more processors of claim 1, wherein the processing circuitry is to allocate the one or more computing resources based, at least in part, on one or more indicated optimal workload amounts.

5. The one or more processors of claim 1, wherein the one or more decoding techniques include at least one of: contrastive decoding, speculative decoding, or best-of-n decoding.

6. The one or more processors of claim 1, wherein the one or more constraints include latency constraints.

7. The one or more processors of claim 1, wherein the processing circuitry is to select the one or more decoding techniques from a plurality of decoding techniques.

8. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

9. A system comprising one or more processors to:
identify one or more decoding techniques based, at least in part, on one or more requests from one or more endpoints; and
cause one or more computing resources to be allocated to perform the one or more decoding techniques to generate one or more responses to the one or more requests.

10. The system of claim 9, wherein the one or more processors are to identify the one or more decoding techniques based, at least in part, on one or more constraints obtained from the one or more endpoints.

11. The system of claim 9, wherein the one or more processors are to identify the one or more decoding techniques based, at least in part, on one or more throughput constraints.

12. The system of claim 9, wherein the one or more processors include one or more graphics processing units (GPUs).

13. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

14. A method comprising:
obtaining one or more requests and one or more constraints;
identifying one or more decoding techniques to generate one or more responses to the one or more requests based, at least in part, on the one or more constraints; and
causing one or more computing resources to perform the one or more decoding techniques to generate the one or more responses.

15. The method of claim 14, further comprising identifying the one or more computing resources based, at least in part, on an indication of an amount of computing resources to be used from one or more users.

16. The method of claim 14, further comprising allocating the one or more computing resources according to the identified one or more decoding techniques to generate the one or more responses.

17. The method of claim 14, further comprising causing the one or more computing resources to perform the one or more decoding techniques to generate at least a token.

18. The method of claim 14, further comprising causing the one or more computing resources to perform the one or more decoding techniques as a result of obtaining the one or more requests from one or more users.

19. The method of claim 14, wherein the one or more constraints include quality constraints.

20. The method of claim 14, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.
